(19) United States
(12) Patent Application Publication
(10) Pub. No.: US 2025/0324500 A1
(43) Pub. Date: Oct. 16, 2025

(54) METHOD FOR GENERATING A NEW LIGHTING FEATURE AND/OR A NEW PIECE OF LIGHTING INFORMATION TAKING INTO ACCOUNT A PIECE OF PERFORMANCE INFORMATION, A COMPUTER SYSTEM CONFIGURED TO EXECUTE THE METHOD AND A COMPUTER PROGRAM PRODUCT COMPRISING SECTIONS OF SOFTWARE CODE

(71) Applicant: MA Lighting Technology GmbH, Waldbüttelbrunn (DE)

(72) Inventors: Alexander Schneider, Waldbrunn (DE); Michael Kohl, Würzburg (DE); Tobias Wursthorn, Bremen (DE)

(21) Appl. No.: 19/094,347

(22) Filed: Mar. 28, 2025

(30) Foreign Application Priority Data
Apr. 12, 2024 (DE) 102024110335.3

(51) Int. Cl. H05B 47/165; H05B 47/16

(52) U.S. Cl. CPC H05B 47/165; H05B 47/16

(57) ABSTRACT

In a method for generating at least one new piece of lighting information (8) and/or at least one new lighting feature, at least one set of training data comprising pieces of performance information (1) and pieces of lighting information (2) assigned to each other is obtained. A machine learning model (5) is created by lighting features (4) and performance features (3) assigned to each other, the lighting features (4) and the performance features (3) being obtained by analysis before and/or during the creation of the machine learning model (5). A new piece of performance information (6) is subsequently obtained and at least one new lighting feature (8) and/or at least one new piece of lighting information is generated by inference with the machine learning model (5) while the new piece of performance information (6) and/or the new performance features (7) obtained by analyzing the new piece of performance information (6) are entered. A computer system (20) is configured to execute the method, which may be executed using a computer program product storing sections of software code configured so a processor executes the method.

The invention relates to a method for generating a new lighting feature and/or a piece of lighting information, a computer system configured to execute the method for generating the lighting information and a computer program product comprising sections of software code with which the method for generating a piece of lighting information is executed by at least one processor.

In the prior art it is known to use light shows for accompanying performances, such as concerts or plays, but also purely auditory performances, such as music in nightclubs, and/or for increasing the visibility of the presentation. As lighting technology advances, the operating staff is provided with an ever-increasing number of options. Therefore, it has become necessary for lighting systems to be controlled using complex automatic control technology. Various control protocols for controlling the individual lighting means have become established. Generally, the light shows are initially programed in parts or fully and are played during the performance, while it is possible to make adjustments to a limited extent.

The light shows are perceived as particularly appealing if they are well coordinated with the presented performance. A close link between the music and the light show is particularly desirable in the case of musical performances or performances underscored by music. For this purpose, an elaborate lighting control sequence must be created with a good knowledge of the piece of music and taking into account the lighting technology on site. Only few assistance systems for this task are known in the prior art.

Methods are known that involve assigning the music to a certain genre or a certain emotion through analysis and thereupon propose a basic color, a light intensity and/or a changing speed. However, this results in light shows that are not very complex, are linked to the music only at a low level and can merely be used as a basis for light shows that are yet to be created and require elaborate further processing and finalization.

Moreover, from U.S. Pat. No. 11,687,760 B2, a method is known, which, with the aid of a multiplicity of previously created light shows, proposes to the user, following the input of first commands, at least one other command which statistically speaking frequently follows the commands entered so far.

The disadvantage of the methods known in the prior art is that the music is not taken into account, or only in a rudimentary way, when the light shows are created, so that the operating staff continues to have a high workload. In particular, with the known methods, it is not possible to propose complex light shows or to assist when they are created, taking into account the performance to be accompanied. In particular, it is also not possible to take the specific existing lighting technology into account in the necessary depth.

There is therefore a great need for a method for generating a piece of lighting information that takes into account the performance to be accompanied in sufficient depth according to the invention, and in this way, largely supports and/or automates the creation of light shows.

This problem is solved in a surprisingly simple, but effective, way by a method according to the teaching of independent claim 1, a computer system according to independent claim 14 and a computer program product according to independent claim 15.

According to the invention, a method for generating a new lighting feature and/or a piece of lighting information comprising the following steps is proposed:
a) Obtaining at least one set of training data comprising at least one piece of performance information, in particular a performance recording, and at least one piece of lighting information, in particular a set of control data, the piece of performance information and the piece of lighting information being assigned to each other;
b) Creating a machine learning model using at least one lighting feature and at least one performance feature, the at least one lighting feature and the at least one performance feature being obtained by analysis before and/or during the creation of the machine learning model, and the at least one performance feature and the at least one lighting feature being assigned to each other;
c) Obtaining a new piece of performance information;
d) Determining at least one new lighting feature and/or at least one new piece of lighting information by inference with the machine learning model while the new piece of performance information and/or at least one new performance feature are entered, the new performance feature being obtained by analyzing the new piece of performance information.

The invention is based on the fundamental idea that at least one correlation between the performance and the lighting is found by analyzing at least one known performance, in particular the sequence of the performance, in connection with at least one lighting solution assigned to the performance, in particular the sequence of the lighting. In accordance with this correlation, a proposal for a new lighting solution taking the new performance into account can be made in the case of an analysis of a new performance for which no lighting solution is known. Here, it should be noted that a larger number and/or better quality of sets of training data leads to better results, meaning more suitable new lighting solutions. Therefore, it is preferred that at least two, three, four, five, six, seven, eight, nine, ten, fifteen, twenty, twenty-five, thirty, thirty-five, forty, forty-five, fifty, fifty-five, sixty, sixty-five, seventy, seventy-five, eighty, eighty-five, ninety, ninety-five, one hundred, one hundred and fifty, two hundred, two hundred and fifty, three hundred, three hundred and fifty, four hundred, four hundred and fifty, five hundred, six hundred, seven hundred, eight hundred, nine hundred, one thousand, five thousand, ten thousand, fifty thousand, one hundred thousand or more sets of training data be obtained in step a).

Further, the result of the new performance feature obtained in step d) and/or the new piece of performance information obtained in step d) can also be improved by targeted selection of the sets of training data of a certain kind of performance if the new performance belongs to the same kind. In this case, sufficiently good results are also achieved in the case of a smaller number of sets of training data.

The sets of training data are obtained in step a). This allows the subsequent steps to be carried out. How the sets of training data are obtained is irrelevant, they preferably come from performances and/or lighting solutions that have been created and performed in this manner by at least one trained and/or experienced person. How the assignment takes place is also irrelevant, as long as it is recognizable by a computer. Particularly preferably, the performance information and the lighting information form a tuple. The performance information and the lighting information can be combined in one file, for example a video recording of a performance that also comprises the lighting solution.

The performance information and the lighting information are analyzed in step b), whereby at least one performance feature and at least one lighting feature are obtained. The at least one performance feature and the at least one lighting feature are assigned to each other. How the assignment is made is irrelevant, as long as it is recognizable by a computer. Particularly preferably, the at least one performance feature and the at least one lighting feature form a tuple. It is preferred that at least one, two, three, four, five, six, seven, eight, nine, ten, fifteen, twenty, twenty-five, thirty, thirty-five, forty, forty-five, fifty, fifty-five, sixty, sixty-five, seventy, seventy-five, eighty, eighty-five, ninety, ninety-five, one hundred, one hundred and fifty, two hundred, two hundred and fifty, three hundred, three hundred and fifty, four hundred, four hundred and fifty, five hundred, six hundred, seven hundred, eight hundred, nine hundred, one thousand, five thousand, ten thousand, fifty thousand or one hundred thousand performance features and/or lighting features are obtained by the analysis in step b). Particularly preferably, at least partially similar performance features and/or lighting features are obtained by the analysis in step b). As a result, it is possible to create a particularly meaningful machine learning model in step b), which can take a large number of performance features and/or lighting features into account. As a result, a more in-depth recognition of the correlations between the performance and the lighting is made possible, so that the new performance can be taken into account to a particularly profound extent when the new lighting feature and/or the new piece of lighting information is generated. It is preferably conceivable that the program that creates the machine learning model and/or the machine learning model itself carries out the analysis, in particular by retrieving and/or executing subroutines and/or functions. Particularly preferably, it is alternatively or additionally conceivable that an analysis is carried out initially and the machine learning model is only created subsequently.

The machine learning model is preferably created in such a way that statistical correlations, structures and/or patterns between the at least one lighting feature and the at least one performance feature are recognized. In other words, the machine learning model is trained with the aid of the features from the analyzed sets of training data. The training is preferably supervised learning, unsupervised learning or reinforcement learning. The machine learning model is particularly preferably an artificial neural network, in particular a recurrent neural network (RNN), a feedforward neural network (FNN), a convolutional neural network (CNN), a transformer, a flow-based generative model, an evolving neural network, an encoder-decoder model, a variational autoencoder, an autoregressive model (ARMA Model), a restricted Boltzmann machine (RBM) and/or a diffusion model, a hidden Markov model (HMM) and/or a support vector machine (SVM). Furthermore, it is conceivable to use the methods of genetic programming, boosting, decision tree machine learning, kernel density estimation (KDE), expert systems (ES), a (naive) Bayes classifier, gradient boosting, linear discriminant analysis, the nearest neighbor classifier, a cluster analysis method, in particular the single linkage method, the complete linkage method, Ward's method, the k-means algorithm, the fuzzy c-means algorithm, the expectation-maximization algorithm (EM algorithm), the DBSAN (density-based spatial clustering of applications with noise), the STING algorithm (statistical information grid-based clustering algorithm) and/or the CLIQUE algorithm (clustering inquest algorithm) and/or a method of anomaly detection, in particular the local outlier factor (LOF), the isolation forest and/or the autoencoder and/or the principal component analysis (PCA). Further, reinforcement learning methods, such as associative reinforcement learning, deep reinforcement learning, adversarial deep reinforcement learning, fuzzy reinforcement learning and/or safe reinforcement learning can be used. In particular, it is conceivable that methods for clustering of data are also used. Suitable measures for creation, use and/or training are known to the person skilled in the art. It is also conceivable that the training data is stored in a database, the database being continuously expanded by new training data during operation or when the method according to the invention is used. Other models with machine learning capability as well as options for creating, using and/or training same are known to the person skilled in the art.

A new piece of performance information is obtained in step c). This new piece of performance information preferably is a piece of performance information for which no new lighting feature and/or no lighting information is yet known. However, it is also conceivable that the piece of performance information is one part of the set of training data, which, however, was not taken into account when the machine learning model was created in the previous step, in order to test the quality of the machine learning model.

In step d), the performance information is preferably analyzed in the same way as in step b) in order to obtain at least one new performance feature. The at least one new performance feature is preferably of the same kind as the at least one performance feature obtained in step b). Further preferably, at least one, two, three, four, five, six, seven, eight, nine, ten, fifteen, twenty, twenty-five, thirty, thirty-five, forty, forty-five, fifty, fifty-five, sixty, sixty-five, seventy, seventy-five, eighty, eighty-five, ninety, ninety-five, one hundred, one hundred and fifty, two hundred, two hundred and fifty, three hundred, three hundred and fifty, four hundred, four hundred and fifty, five hundred, six hundred, seven hundred, eight hundred, nine hundred, one thousand, five thousand, ten thousand, fifty thousand or one hundred thousand new performance features, the respective kind of which corresponds at least partially to the respective kind of the performance features obtained in step b), are obtained. It is conceivable that the machine learning model itself carries out the analysis, in particular by retrieving and/or executing subroutines and/or functions. Particularly preferably, it is alternatively or additionally conceivable that an analysis is carried out initially and the new performance feature is subsequently fed to the machine learning model to be created in step c), this determining at least one new lighting feature and/or one new piece of lighting information by inference.

The term “performance information” relates to a description and/or recording of a presentation, in particular a piece of music and/or a stage production, in a way that is processable by a computer. Examples of performance information are given elsewhere.

The term “lighting information” refers to a description and/or recording of a light show accompanying a performance in a way that is processable by a computer. Examples of lighting information are given elsewhere.

The term “assign” refers to a state in which the piece of performance information and the piece of lighting information are placed in a relation in a manner that is recognizable by a computer and/or are recognizable as belonging to each other.

The term “machine learning model” relates to a program that is configured to recognize statistical correlations, patterns and/or structures between lighting information, lighting features, performance information and/or performance features without any explicit specification in the programming and, based on this, is configured to determine at least one new piece of lighting information and/or at least one new lighting feature on the basis of a new piece of performance information and/or at least one new performance feature. In particular, the term “create” refers to a first-time training of the machine learning model.

The term “analyze” refers to the systematic examination, preferably in whole, of the piece of performance information, the new piece of performance information and/or the piece of lighting information, in particular a dissection, a decomposition into the components, an arrangement, a classification and/or an abstraction of the whole, of individual members and/or of the components being carried out in this process.

The term “feature” refers to a result of the analysis that describes, classifies, arranges, places in a relation and/or structures the piece of performance information, the new piece of performance information or the piece of lighting information in whole or in part. Here, the term “feature” is not limited to the extent that a feature can be comprehended, interpreted, read out and/or understood by a human, in particular outside the machine learning model. Examples of features are given elsewhere.

The term “obtain” relates to the provision of the piece of performance information, the piece of lighting information, the at least one performance feature, the at least one lighting feature, the at least one new piece of performance information, the at least one new performance feature and/or the at least one new lighting feature in a form in which a computer executing the method can further treat and/or further process same.

The term “inference” refers to the derivation of at least one new lighting feature and/or at least one new piece of lighting information using the machine learning model created by training.

By means of the invention, it is possible to quickly and easily create proposals for entire light shows or parts of a light show in connection with the performance and thus easily underscore corresponding performances in terms of lighting technology. In particular, it is possible to provide the light shows as data packets that can be sent directly to the lighting means and/or to display proposals for lighting features to the user creating a light show.

Advantageous further developments of the invention, which can be realized individually or in combination, are presented in the subclaims.

It is conceivable that the method comprises a step e) after step d):

e) Generating at least one lighting control command from the at least one new lighting feature.

As described elsewhere, it has been recognized in the context of the invention that certain protocols are used to control modern lighting systems and that the individual lighting means are controlled thereby using lighting control commands. It is therefore advantageous and time-saving if the new lighting feature is converted into a lighting control command. In this way, the control can be carried out directly on the basis of the at least one lighting feature, and a lighting program or a light show or part of a light show can be created fully automatically. Additionally or alternatively, it would be conceivable to output the new lighting feature to the person creating the light show in a way that is quickly and easily understandable for the human. However, it is also conceivable that the lighting information received in step d) comprises a lighting control command.

In a further development of the invention, it is conceivable that the performance information and the lighting information comprise a time component, a value of the time component being assigned and/or having been assigned to the at least one performance feature and the at least one lighting feature in step b) and the value of the time component being taken into account when the machine learning model is created, and that the new performance information in step c) comprises a new time component, a new value of the new time component being assigned and/or having been assigned to the new performance feature in step d) and the determination of the at least one new lighting feature and/or of the at least one new piece of lighting information by inference with the machine learning model taking the new value of the new time component into account. In particular, the time component can be a period of time that has elapsed since the start of the performance. In particular, the time component can be specified in seconds, minutes and/or hours. However, it is also conceivable that the time component is determined on the basis of recurring elements in the performance, in particular by counting. This is the case, for example, if the performance is a piece of music and the time component is measured in the number of past bars or beats. Precise synchronization between the lighting and the performance can be achieved through this kind of time description. The preferred design has the advantage that preferred lighting features associated with the timing sequence of the performance are taken into account by the machine learning model and better, meaning considered more suitable, new lighting features can be determined in this way. In the context of the invention, it has been recognized, for example, that more subdued light is often selected, particularly at the beginning of the performance, meaning in the case of low values of the time component of the performance, than in the middle of the performance.

The term “take into account” relates to the measurable provision of the time component and/or the new time component in a way that the machine learning model can, but does not have to, recognize statistical correlations, patterns and/or structures therein, in particular in relation to the other features and/or pieces of information.

In a further development, it is conceivable that at least two performance features and at least two lighting features are analyzed and a first value of the time component is assigned and/or has been assigned to the first performance feature and the first lighting feature and a second value of the time component is assigned and/or has been assigned to the second performance feature and the second lighting feature, and the relation between the first value of the time component and the second value of the time component is taken into account when creating the machine learning model in step b), at least two new performance features being obtained and a first new value of the new time component being assigned to the first new performance feature and a second new value of the new time component being assigned to the second new performance feature, and the determination of the at least one new lighting feature and/or the at least one new piece of lighting information by inference with the machine learning model taking into account the relation between the first new value of the new time component and the second new value of the new time component in step d). It has been recognized in the context of the invention that it is not only the temporal distance and/or the elapsed time in the performance but also the temporal relation of a first position in the performance to other positions in the performance which is generally decisive for selecting the lighting feature. For example, the lighting strategy selected when there is a change from one musical section to another with a change from fast to slow is generally different from the lighting strategy selected when there is a change from slow to fast. The use of at least two features with different time components allows this interrelation to be depicted and taken into account. Particularly appealing light shows can thereby be created.

Moreover, it is conceivable that the analysis in step b) and/or in step d) is at least two-stage, at least one performance feature of the first stage being obtained directly from the piece of performance information and/or a lighting feature of the first stage being obtained directly from the piece of lighting information in a first stage of the analysis, and at least one performance feature of the n-th stage being obtained from the piece of performance information and/or a performance feature of a lower stage and/or a lighting feature of the n-stage being obtained directly from the piece of lighting information and/or at least one lighting feature of a lower stage that has been obtained, in an n-th stage of the analysis. In other words, a first feature is obtained in a first stage of the analysis, which, together with the piece of information itself forms the basis for a second analysis of a second stage, whereby a feature of the second stage is obtained. This can be followed by other stages of the analysis, each of which takes into account a feature of the lower stages. This is preferably at least one feature from the immediately preceding stage of the analysis. It has been recognized in the context of the invention that meaningful features can form the basis for further analysis. In particular, it is possible to assign an emotion from different features to a piece of music, these features possibly comprising in particular the tempo, pitch, key, vocal range, the selection of instruments and/or the way the instruments are played. These features can be determined during one or multiple previous analyses, the emotion being determined from these features during a subsequent analysis. The analysis preferably comprises at least three, four, five, six, seven, eight, nine, ten, eleven, twelve, thirteen, fourteen, fifteen, sixteen, seventeen, eighteen, nineteen or twenty stages. In the case of the multi-stage analysis, further preferably the method of analysis is selected in the second and/or a higher stage on the basis of at least one performance feature of a lower stage and/or its value, on the basis of at least one lighting feature of a lower stage and/or its value and/or on the basis of at least one new performance feature of a lower stage and/or its value. It has been recognized in the context of the invention that statistical correlations, patterns and/or structures can also result from the specific values of the features and that, based on these values, certain analyses can be useful.

The term “nth stage” refers to a stage denoted by a series of natural numbers, n being an element of the set of natural numbers without 1. In other words, an “nth stage” is an arbitrary stage from the logically continued series of the second stage, third stage, fourth stage.

In a further development of the invention, it is conceivable that the piece of performance information and/or the new piece of performance information comprises an audio file, in particular an audio recording, a video file, in particular a video recording, a sheet of music and/or a text. The audio file is particularly preferably a piece of music. Further preferably, the video file is a video recording of a musical performance and/or a stage work, in particular a theater performance, an opera, a musical, a ballet and/or a dance performance. Further preferably, the text is a description and/or instructions relating to the aforementioned works. Particularly preferably, the illustration, in particular the sequence of illustrations, shows a choreography, a scenery and/or a staging. Further preferably, the text comprises a description and/or a textual fixation of a stage work and/or a textual fixation of a choreography. The person skilled in the art is aware of file formats that are suitable for obtaining and/or analyzing the preferred kinds of performance information or new kinds of performance information, which have been enumerated above, such as involving a computer, a computer system and/or a computer program.

It is preferably conceivable that the piece of lighting information comprises at least one set of control data and/or a packet of control data, at least one set of simulation data, at least one model, in particular a virtual 3D model, at least one text, in particular a description of concept and/or a script, at least one illustration, in particular a series of illustrations, at least one cue, in particular a series of cues, at least one preset, at least one sequence, at least one stack, at least one graph, in particular a graph with position information and/or with movement information, at least one plan, in particular a layout plan, at least one video file, in particular a video recording and/or a simulation, at least one description, in particular a description comprising a patch, at least one cluster and/or at least one algorithm and/or at least one packet of data, in particular comprising recipes, MAtricks, phasers, timecodes, macros, Lua plugins, filters, selections, effects, bitmaps and/or generators. The packet of control data is particularly preferably a DMX data packet or an ArtNet data packet. These are the most common protocols for controlling lighting technology. Particularly preferably, the control data set itself comprises at least one preset, at least one cue, at least one sequence and/or at least one stack. Preferably, the set of simulation data is a simulation of a stage with lighting means arranged thereon. Particularly preferably, these lighting means execute movements and/or setting changes, such as switching on and off, changes in intensity, focus, shape and/or color. Further preferably, the model also shows a stage with lighting means. Further preferably, the text comprises a description, in particular a description of concept and/or a script, of a lighting sequence on a stage. Further preferably, the text comprises a number of and/or a cluster of lighting means as well as their type. Particularly preferably, the illustration, in particular the series of illustrations, shows different lighting means of a stage arranged in chronological order. Particularly preferably, the graph shows the positioning and/or the movement sequences along with the lighting means. Further preferably, the plan shows the position information and/or information of individual, preferably all, lighting means. Even more preferably, the plan comprises a layout plan listing a number and/or kind and/or type of lighting means. Further preferably, the video file, in particular the video recording and/or the simulation, shows the sequence of a light show. Further, it is conceivable that the piece of lighting information is composed of multiple of the aforementioned features. In particular, it is conceivable that the piece of lighting information comprises a set of control data and a set of simulation data that implements the set of control data. Further, it is advantageous if the piece of lighting information comprises at least one data packet, the data packet having been extracted from lighting control software and/or from interfaces to lighting control software. The piece of lighting information is usually available in whole and/or comprehensively in the lighting control software, so that it can be evaluated in a particularly meaningful and lossless manner.

Furthermore, it is conceivable that the piece of performance information and/or the new piece of performance information comprises a piece of music information, in particular a music recording, the performance feature and/or the new performance feature being the tempo, the beat, the rhythm, the key, the sound sequence, the pitch, the vocal range, the instrument used and/or the instruments used, the kind of use of the instrument and/or the kind of use of the instruments, the arrangement, the lyrics, the frequency spectrum, the amplitude, the frequency deflection, the onset strength, the effective value, in particular the effective value of the frequency, the MFCCs (mel frequency cepstral coefficients), a channel, in particular a direction assigned to the channel, an emotion, a musical genre, a change thereof and/or a number thereof. Methods of analysis for extracting these performance features from a piece of music information are known to the person skilled in the art. Furthermore, suitable methods of analysis are mentioned elsewhere. The features can also be recorded in relation to the overall musical performance. The aforementioned performance features are generally consciously or unconsciously taken into account when light shows for musical performances are created.

The term “channel” refers to the division of an audio track of synchronously recorded parts of an audio file, the individual audio tracks subsequently being encoded in such a way that they are played on one or more loudspeakers, so that a spatial sound image results for the listener. The term “direction” refers to the positioning in the room relative to the listener.

The term “emotion” refers to an assignment of the piece of music to a feeling that the listener generally associates with the piece of music. On the one hand, it is conceivable to use known algorithms and/or structures of analysis and/or to train a neural network to recognize emotions with corresponding sets of training data. In particular, the at least two-stage analysis method described elsewhere can be used here. In particular, the analysis of a higher stage can also be carried out by a machine learning model.

In a further development of the invention, it is conceivable that the analysis of the performance information in step b) and/or the analysis of the new performance information in step e) comprises the creation of a chromagram, in particular a constant-Q chromagram and/or an STFT chromagram, a tempogram a spectrogram, in particular a constant-Q spectrogram or an STFT spectrogram, a periodogram, a similarity matrix, a distribution of frequency of changes, a correlation measure, a novelty function and/or a beat track and/or a separation of melody and percussion sources. Suitable means for carrying out the aforementioned methods of analysis are known to the person skilled in the art. Further, it is conceivable that these methods of analysis are carried out at a higher stage in the case of a multi-stage analysis procedure. Reference is made to the 2nd edition of the reference book, “Fundamentals of Music Processing using Python and Jupyter Notebooks” by Meinard Müller published by Springer-Verlag. The results of the analysis represent performance features and/or new performance features, in particular the previously listed performance features and/or new performance features.

Furthermore, it is conceivable that the lighting feature and/or the new lighting feature is the light color, the hue, the color temperature, the brightness, the zoom, the focus, the iris, the shape, the orientation, the twist, the position, an arrangement, a status, a type, a mood, a number of lighting means, in particular a number of lighting means of one type, a maximum value thereof, a minimum value thereof, and/or a change thereof. The aforementioned features or changes thereto define the typical sequence of a light show. They can be obtained individually for some or all of the lighting means or can be obtained collectively for multiple lighting means by a cluster.

The term “zoom” refers to the strength of the concentration of a light beam from a lighting means.

The term “focus” refers to the sharpness of the image, in particular around the edge area of the light beam.

The term “iris” refers to the aperture of a diaphragm.

The term “shape” refers to the design of the edge of the light beam, which can be influenced by diaphragms or by the arrangement of multiple light sources.

The term “orientation” refers to the direction in which the main axis of a lighting means is oriented.

The term “twist” refers to the rotation of a lighting means around its main axis.

The term “position” refers to the arrangement of a lighting means in a room and/or on a stage.

The term “arrangement” refers to the positioning of a lighting means relative to another lighting means or to multiple other lighting means, in particular to another lighting means or to other lighting means of the same type.

The term “status” refers to the state of a lighting means, in particular whether it is switched on or off.

The term “type” refers to the kind of lighting means. In particular, the type of lighting means can be a PAR spotlight, a blinder, a floodlight, a lens spotlight, a moving head, a scanner, a show laser, an LED spotlight, an area light, a horizontal light and/or a moving light. Other lighting means and methods for controlling them are known to the person skilled in the art.

The term “mood” refers to an emotion that is associated with certain values of the aforementioned features or changes in the features.

The term “maximum value” refers to the maximum setting of the aforementioned features. The term “minimum value” refers to the minimum setting of the aforementioned features. The term “change” refers to a change in the setting of the aforementioned features.

In a further development, it is conceivable that the analysis of the lighting information in step b) comprises the creation of a cluster, in particular a cluster of lighting means on the basis of type, orientation and/or position, an arrangement, a similarity matrix and/or a distribution of frequency of changes. It has been recognized in the context of the invention that lighting means in the context of a light show, in particular lighting means of the same type, the same and/or similar orientation and the same and/or similar position, execute similar features and/or movement sequences as well as changes thereof. It is also conceivable that a temporal offset occurs between the features and/or the execution among the individual lighting means in the cluster. It is not so much a question of the number of lighting means, but rather a question of the aforementioned aspects. If the lighting means are initially divided into clusters, a multitude of light shows are more similar and/or comparable in this regard, so that a more stable and/or more meaningful machine learning model can be created. The cluster represents an abstraction of the light show, the abstraction facilitating the creation of a machine learning model. Further, it has been recognized in the context of the invention that light shows, in particular light shows accompanying pieces of music, have similar features in the case of similar parts of the pieces of music. Therefore, there are statistically significant parallels between the similarity matrix of a piece of music and the similarity matrix of a light show in particular.

Moreover, it is conceivable that at least one location feature is taken into account in step b) when the machine learning model is created and/or at least one new location feature is taken into account in step d) when the at least one new lighting feature and/or the at least one new piece of lighting information is determined, the location feature and/or the new location feature being the ambient brightness, the time of day, a dimension, in particular a dimension of a stage and/or an audience area, a seat category, a number of visitors, a venue and/or an audience atmosphere. It has been recognized in the context of the invention that the aforementioned features can have a strong influence on the design of the light show.

The term “audience area” refers to an area that is intended to be filled with an audience when there is a performance.

The term “seat category” refers to a kind or arrangement of a seat, in particular a standing space, a seat and/or the location of a seat category.

The term “number of visitors” refers to the planned and/or actual number of visitors when there is a performance.

The term “venue” refers to the kind of location where the performance takes place. In particular, a concert hall, a concert room, a stadium and/or an open space is a kind of venue.

The term “audience mood” refers to the envisaged, anticipated and/or actual mood that prevails and/or should prevail in the audience.

In a further development of the method, it is conceivable that the method comprises a step f) after step d):

f) Evaluating the at least one new lighting feature and/or the at least one new piece of lighting information.

The evaluation is preferably carried out by the person to whom the lighting feature is proposed. By using the evaluated lighting feature, it is possible to improve and/or individualize the machine learning model. As a result, the new lighting features determined by the machine learning model are better and/or more individualized for future implementation of the method. The quality of the light show is improved as a result.

It is assumed that the definitions and/or explanations of the above-named terms apply to all aspects described in this description in the following, unless otherwise stated.

The invention further proposes a computer system configured to execute a method according to claims 1 to 13, the computer system comprising at least one interface for obtaining at least one set of training data and/or for obtaining the new pieces of performance information for carrying out step a) and step c), a computer readable storage medium for creating and/or for storing the machine learning model for carrying out step b) and step d) and at least one data processing device for carrying out step b) and step d). The computer system preferably comprises at least two interfaces, one interface being comprised for obtaining the at least one set of training data for carrying out step a) and the second interface being comprised for obtaining the new piece of performance information of step d). Particularly preferably, the computer system comprises another interface and/or the at least one interface for outputting the at least one new performance feature. The advantages described in connection with the method are achievable by the computer system. Particularly preferably, the computer system comprises a database and/or an interface for a database, in particular a database for sets of training data for creating and/or improving the machine learning model.

Further, a computer program product comprising sections of software code that are configured in such a way that a method according to one of the method claims 1 to 13 is executable by at least one processor is proposed according to the invention. The advantages of the method described in connection with the method can be realized as a result. The sections of software code are preferably stored on a non-volatile, computer-readable storage medium.

Further details, features and advantages of the invention result from the following description of the preferred embodiments in conjunction with the subclaims. Here, the respective features can be realized on their own or as multiple features in combination with each other. The invention is not limited to the embodiments. The embodiments are shown schematically in the figures. Identical reference numerals in the individual figures indicate identical or functionally identical elements or elements that correspond to each other in terms of their function.

In the figures

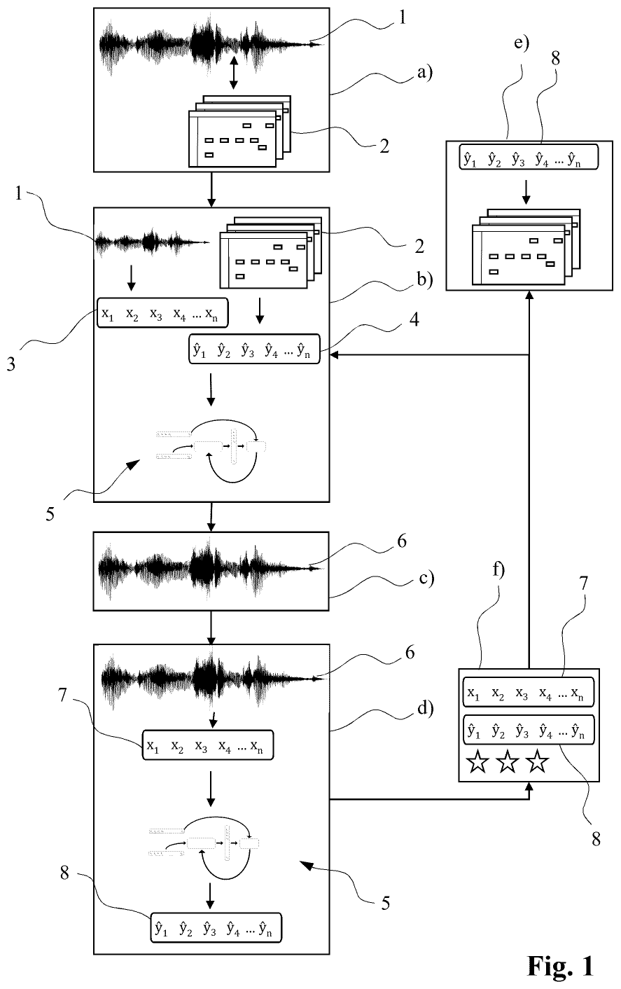

FIG. 1 shows an embodiment of a method according to the invention;

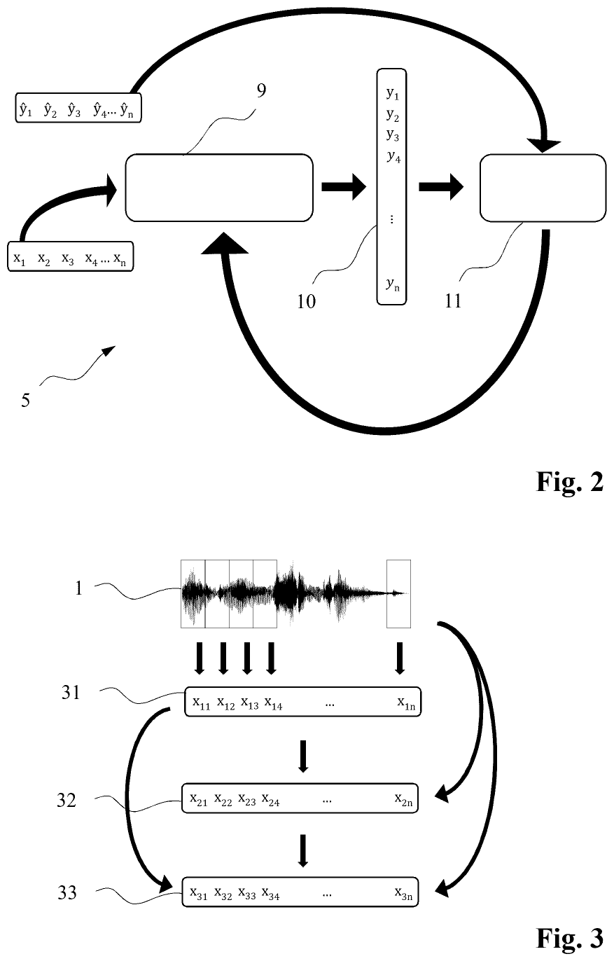

FIG. 2 shows an embodiment of a machine learning model according to the invention;

FIG. 3 shows an embodiment of a multi-stage method of analysis according to the invention;

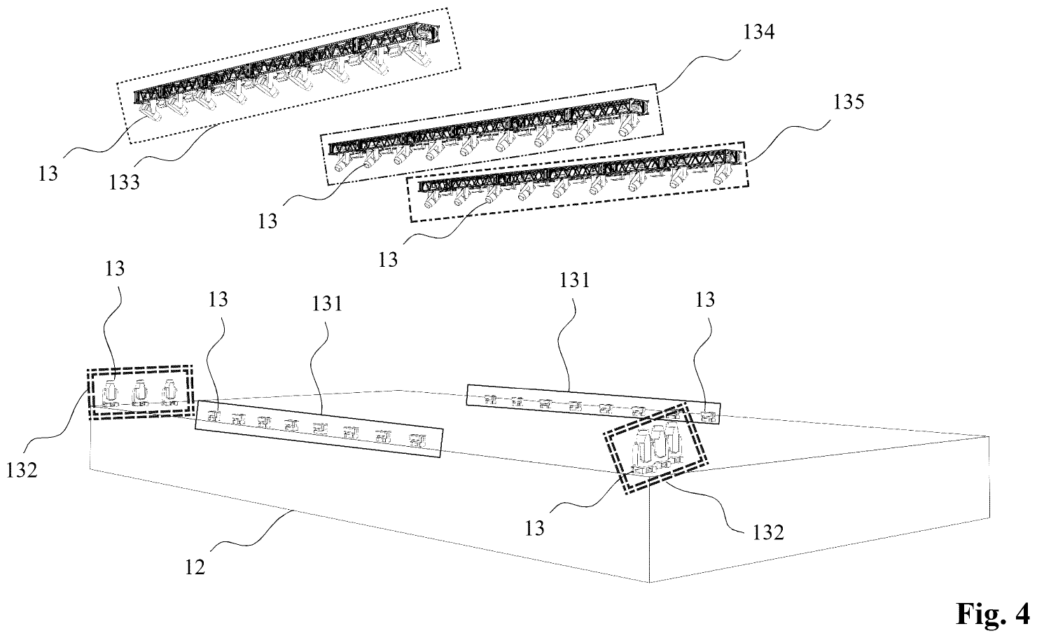

FIG. 4 shows an embodiment of a cluster of lighting means according to the invention; and

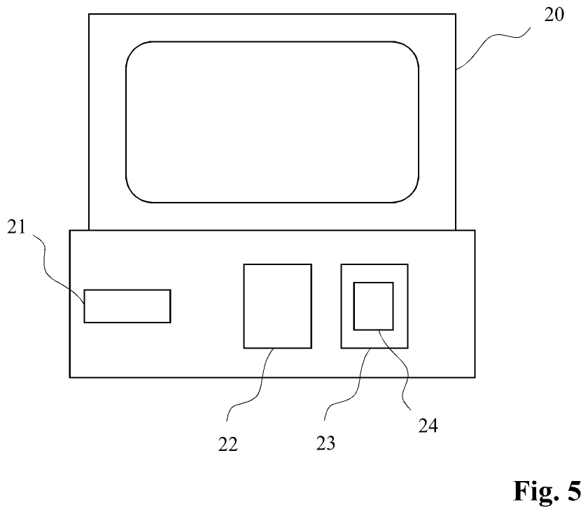

FIG. 5 shows an embodiment of a computer system according to the invention.

FIG. 1 shows a preferred embodiment of the method according to the invention. Multiple sets of training data are obtained in a first step a), the sets of training data comprising multiple pieces of performance information 1 and pieces of lighting information 2 assigned to the pieces of performance information 1. In the embodiment shown, the pieces of performance information 1 each comprise a recording of a live performance of a piece of music accompanied by a light show. The recording comprises an audio track that is part of the piece of performance information 1. The light show is captured in the form of a sequence of ArtNet frames. The piece of lighting information 2 comprises these ArtNet frames. The ArtNet frames are also assigned a value of a time component by assigning timestamps thereto in accordance with the recording. A step a) is followed by a step b) in which the pieces of performance information 1 and the pieces of lighting information 2 are initially analyzed, whereby multiple performance features 3 and multiple lighting features 4 are obtained. The lighting features 4 and the performance features 3 are assigned the values of the time component in each case. A similarity matrix is also created for the audio track and the ArtNet frames in each case. A machine learning model 5 is subsequently created on the basis of the pieces of performance information 1 and the pieces of lighting information 2, which is explained in more detail in FIG. 2. In the next step c), a new piece of performance information 6 is obtained, which is a recording of a piece of music and also comprises an audio track. The new piece of performance information 6 is also analyzed in the subsequent step d), and multiple new performance features 7 are obtained, these also being linked to values of the time component. A similarity matrix is also created here. The new performance features 7 are fed to the machine learning model 5 created in step b), which determines multiple new lighting features 8 by inference. In a subsequent step f), the new lighting features 8 are evaluated and the result is fed to the machine learning model 5 created in step b) together with the new lighting features 8 and the new performance features 7 for improvement. In a step e), a lighting control command is created from the at least one new lighting feature 8.

FIG. 2 shows the machine learning model 5 used in the method shown in FIG. 1. The performance features 3 and the lighting features 4 are entered into the machine learning model 5, which is formed as a sequence-to-sequence generation model 9 based on a neural network. The lighting features 4 form target values for error feedback. The generation model 9 generates intermediate features 10, which are entered in a monitoring module 11 to determine the loss function, which is part of the error feedback. The monitoring module 11 evaluates the values of the intermediate features 10 by means of the loss function and returns the evaluation to the generation model 9 as a feedback. The generation model 9 then creates new intermediate features 10. The machine learning model 5 is trained in this way.

FIG. 3 shows an embodiment of a three-stage analysis of a piece of performance information 1 according to the invention. In a first stage, performance features of the first stage 31 are obtained directly from the piece of performance information. In a second stage, performance features of the second stage 32 are obtained from the performance features of the first stage 31 and the piece of performance information. In a third stage, performance features 33 of the third stage are obtained from the performance features of the first stage 31, the performance features of the second stage 32 and the piece of performance information.

FIG. 4 shows an embodiment of a cluster of lighting means 13 according to the invention, which are arranged on a stage 12. Clustering was carried out on the basis of type and arrangement of the lighting means, as similar types of lighting means 13 that are arranged in relation to each other, for example in a row, frequently execute similar movements and/or setting changes. For example, the effect achieved by a series of five similar lighting means 13 by staggered execution of movements and/or setting changes can be achieved in the same way by a series of six similar lighting means 13. The movements and/or setting changes can be executed simultaneously, but also in a staggered manner, mirror-inverted and/or twisted in relation to each other. The clusters primarily serve to abstract the arrangement of the lighting means 13 and, with that, to reduce the amount of data and make it more comparable. The lighting means 13 arranged in the front area and in the rear area on the stage form a first cluster 131. They are able to emit light in different colors and can be swiveled in the process. A second cluster 132 is formed by the lighting means 13 that are arranged on the side of the stage and have different rotatable gobos that can change color, are tiltable and have an adjustable focus, iris and zoom. A third cluster 133, a fourth cluster 134 and a fifth cluster 135 are each formed by the lighting means 13 arranged on the traverses. The lighting means 13 of the third cluster 133, the fourth cluster 134 and the fifth cluster 135 can also change color, are tiltable and also have an adjustable focus, iris and zoom. All the lighting means are controllable by a DMX ArtNet protocol.

FIG. 5 shows a computer system 20 according to the invention with an interface 21 for obtaining sets of training data and new pieces of performance information, a computer-readable storage medium (22) for creating and storing the machine learning model, a computer program product being stored on the storage medium (22), and a data processing device (23) comprising a processor (24). The computer program product has sections of software code that are configured in such a way that the method described elsewhere is executable by the processor (24).

1. A method for generating a new piece of lighting information or a new lighting feature, said method comprising:
i) obtaining at least one set of training data comprising at least one piece of performance information comprising a performance recording, and at least one piece of lighting information comprising a set of control data, the piece of performance information and the piece of lighting information being assigned to each other;
ii) creating a machine learning model using at least one lighting feature and using at least one performance feature the at least one lighting feature and the at least one performance feature being obtained by analysis before and/or during the creating of the machine learning model, and the at least one performance feature and the at least one lighting feature being assigned to each other;
iii) obtaining a new piece of performance information;
iv) determining at least one new lighting feature and/or at least one new piece of lighting information by inference with the machine learning model while the new piece of performance information and/or at least one new performance feature are entered, the new performance feature being obtained by analyzing the new piece of performance information.

2. The method according to claim 1, wherein the method further comprises, after step d):
e) generating at least one lighting control command from the at least one new lighting feature.

3. The method according to claim 1, wherein the piece of performance information and the piece of lighting information each comprise a respective time component,
wherein a value of the time component is assigned and/or has been assigned to the at least one performance feature and the at least one lighting feature in step b), and the value of the time component is used when creating the machine learning model,
wherein the new performance information comprises a new time component, wherein a new value of the new time component is assigned and/or has been assigned to the new performance feature in step d), and
wherein the determination of the at least one new lighting feature and/or the at least one new piece of lighting information by inference with the machine learning model is based at least in part on the new value of the new time component.

4. The method according to claim 3, wherein at least two performance features and at least two lighting features are obtained by analysis, and a first value of the time component is assigned and/or has been assigned to a first of the performance features and a first of the lighting features and a second value of the time component is assigned and/or has been assigned to a second of the performance features and a second of the lighting features in step b),
wherein a relation between the first value of the time component and the second value of the time component is used when creating the machine learning model,
wherein at least two new performance features are obtained by analysis and a first new value of the new time component is assigned to a first of the new performance features and a second new value of the new time component is assigned to a second of the performance features in step d); and
wherein the determination of the at least one new lighting feature and/or the at least one new piece of lighting information by inference with the model is based at least partly on a relation between the first new value of the new time component and the second new value of the new time component.

5. The method according to claim 1, wherein the analysis in step b) and/or in step d) is at least two-stage,
wherein, in a first stage of the analysis, at least one performance feature of the first stage is obtained directly from the piece of performance information, at least one new performance feature of the first stage is obtained directly from the new piece of performance information, and/or a lighting feature of the first stage is obtained directly from the piece of lighting information,
wherein, in an n-th stage of the analysis, which is not the first stage of the analysis, at least one performance feature of the n-th stage is obtained from the piece of performance information and/or from at least one performance feature of a lower stage, at least one new performance feature of the n-th stage is obtained from the new piece of performance information and/or from at least one new performance feature of a lower stage, and/or a lighting feature of the n-th stage is obtained directly from the piece of lighting information and/or from at least one lighting feature of a lower stage.

6. The method according to claim 1, wherein the piece of performance information and/or the new piece of performance information comprises an audio file, including an audio recording, a video file, in including a video recording, at least one illustration, including a sequence of illustrations, a sheet of music and/or a text.

7. The method according to claim 1, wherein the piece of lighting information comprises at least one set of control data, at least one set of simulation data, at least one model, at least one text, at least one illustration, at least one cue, at least one preset, at least one sequence, at least one stack, at least one graph, at least one plan, at least one video file, at least one description, at least one cluster and/or at least one algorithm and/or at least one data packet.

8. The method according to claim 1, wherein the piece of performance information and/or the new piece of performance information comprises a piece of music information, and the performance feature and/or the new performance feature comprises a tempo, a beat, a rhythm, a key, a sound sequence, a pitch, a vocal range, an instrument used, a kind of use of the instrument, an arrangement, lyrics, a frequency spectrum, an amplitude, a frequency deflection, an onset strength, an effective value, MFCCs (mel frequency cepstral coefficients), a channel, an emotion, a musical genre, a change thereof and/or a number thereof.

9. The method according to claim 1, wherein the analysis of the piece of performance information in step b) and/or the analysis of the new piece of performance information in step d) comprises creation of a chromagram, a spectrogram, a periodogram, a similarity matrix, a distribution of frequency of changes, a correlation measure, a novelty function, a beat track and/or a separation of melody and percussion sources.

10. The method according to claim 1, wherein the lighting feature and/or the new lighting feature is a color of light, a hue, a color temperature, a brightness, a zoom, a focus, an iris, a shape, an orientation, a twist, a the position, an arrangement, a status, a type, a mood, a number of lighting devices, a maximum value thereof, a minimum value thereof and/or a change thereof.

11. The method according to claim 1, wherein the analysis of the piece of lighting information in step b) comprises the creation of a cluster, an arrangement, a simulation, a similarity matrix and/or a distribution of frequency of changes.

12. The method according to claim 1, wherein at least one location feature is used when creating the machine learning model in step b) and/or at least one new location feature is used when determining the at least one new lighting feature and/or the new piece of lighting information in step d), the location feature and/or the new location feature being ambient brightness, time of day, a dimension, a seating category, a number of visitors, a kind of venue and/or an audience atmosphere.

13. The method according to claim 1, wherein the method comprises after step d):
e) evaluating the at least one new lighting feature and/or the at least one new piece of lighting information.

14. A computer system configured to execute the method according to claim 1, said computer system comprising
at least one interface obtaining the at least one set of training data and/or obtaining the new piece of performance information in carrying out step a) and step c),
a computer-readable storage medium creating and/or storing the machine learning model in carrying out step b) and step d), and
at least one data processing device that is configured to carry out step b) and step d).

15. A computer program product comprising computer accessible data storage storing therein sections of software code that are configured so that at least one processor executes a method according to claim 1.

16. The method according to claim 1, wherein the piece of performance information and/or the new piece of performance information comprises an audio recording, a video recording, or a sequence of illustrations.

17. The method according to claim 1, wherein the piece of lighting information includes a control code and/or a packet of control data, a virtual 3D model, a text description of concept and/or a script, a series of illustrations, a series of cues, a graph with position information and/or movement information, at least one plan, a layout plan, a video recording and/or a simulation, a description comprising a patch, at least one data packet comprising recipes, MAtricks, phasers, timecodes, macros, Lua plugins, filters, selections, effects, bitmaps and/or generators.

18. The method according to claim 1, wherein the piece of lighting information comprises a control code and/or a packet of control data, a virtual 3D model, a description of concept and/or a script, a series of illustrations, a series of cues, a graph with position information and/or movement information, a layout plan, a video recording and/or a simulation, a description comprising a patch, and/or at least one data packet comprising recipes, MAtricks, phasers, timecodes, macros, Lua plugins, filters, selections, effects, bitmaps and/or generators.

19. The method according to claim 1, wherein the piece of performance information and/or the new piece of performance information comprises a piece of music information including a music recording, and the performance feature and/or the new performance feature comprises an effective value of the frequency, MFCCs (mel frequency cepstral coefficients), a channel, a direction assigned to a channel.

20. The method according to claim 1, wherein the analysis of the piece of performance information in step b) and/or the analysis of the new piece of performance information in step d) comprises creation of a constant-Q chromagram or an STFT chromagram, a tempogram, a constant-Q spectrogram or an STFT spectrogram, a periodogram, a similarity matrix, a distribution of frequency of changes, a correlation measure, a novelty function, a beat track and/or a separation of melody and percussion sources.

21. The method according to claim 1, wherein the analysis of the piece of lighting information in step b) comprises the creation of a cluster of lighting devices on a basis of type, orientation and/or position, an arrangement, a simulation, a similarity matrix and/or a distribution of frequency of changes.

22. The method according to claim 1, wherein at least one location feature is used when creating the machine learning model in step b) and/or at least one new location feature is used when determining the at least one new lighting feature and/or the new piece of lighting information in step d), the location feature and/or the new location feature being ambient brightness, time of day, a dimension of a stage and/or an audience area, a seating category, a number of visitors, a kind of venue and/or an audience atmosphere.
